(19) United States
(12) Patent Application Publication
(10) Pub. No.: US 2011/0096966 A1
(43) Pub. Date: Apr. 28, 2011

(54) METHOD AND APPARATUS FOR DETECTING BONE VARIABILITY WITH ULTRAVIOLET LIGHT

(75) Inventors: Irving Weinberg, Bethesda, MD (US); Mario Urdaneta, Berwyn Heights, MD (US); Pavel Stepanov, North Potomac, MD (US)

(73) Assignee: Weinberg Medical Physics LLC

(21) Appl. No.: 12/961,736

(22) Filed: Dec. 7, 2010

Related U.S. Application Data
(63) Continuation-in-part of application No. 12/535,236, filed on Aug. 4, 2009.
Application No. 12/535,236 is a continuation of application No. PCT/US10/59052, filed on Dec. 6, 2010.
(60) Provisional application No. 61/267,322, filed on Dec. 7, 2009.
(60) Provisional application No. 61/086,402, filed on Aug. 5, 2008.

(51) Int. Cl. G06K 9/00; G06F 19/00

(52) U.S. Cl. 382/128; 702/19

(57) ABSTRACT

A method and apparatus for assessing the time since demise of one or more tissue components, comprising a source of radiation to generate excitatory radiation toward a tissue component, the tissue component generating responsive radiation in response to the excitatory radiation, a sensor to receive the responsive radiation from the tissue component and create a signal indicating the rate of change (over time) of the responsive radiation, a processor connected to the sensor to receive the signal from the sensor, and wherein the processor evaluates the received signal and provides information whereby a user can assess the time since demise of the tissue component based on responsive radiation generated by the tissue component as a result of excitation of at least one intrinsic tissue component metabolic product.

### CROSS-REFERENCE TO RELATED APPLICATION(S)

This application claims the benefit of U.S. Provisional Application No. 61/267,322 filed Dec. 7, 2009, the contents of which are incorporated herein by reference. This application is a continuation-in-part of U.S. application Ser. No. 12/535,236 filed Aug. 4, 2009, the contents of which are incorporated herein by reference. This application is a continuation of PCT Application No. PCT/US10/59052, the contents of which are incorporated by reference.

### FIELD OF THE INVENTION

The present invention concerns an apparatus and a method for detecting bone viability with ultraviolet light.

### BACKGROUND OF THE INVENTION

Many diabetic patients suffer from one or more factors (e.g., reduced blood flow, impaired immune response, neuropathies) that predispose them to osteomyelitis. About a quarter of American diabetic patients will have foot problems. Among hospital admissions for diabetes, 20% are for foot osteomyelitis. Antibiotic treatment of osteomyelitis is long, expensive and often ineffective, leading to the aggressive use of preventive surgery at an early stage. Obviously it is the goal of the surgeon to resect as little healthy tissue as possible, in order to preserve normal gait and stance. Given this goal, there is diversity of opinion within the diabetic care community as to appropriate algorithms for debridement while minimizing resection volumes.

One time-honored approach to surgical planning is to continuously examine remaining bone for punctuate bleeding (“paprika sign”). The degree of bleeding required to establish adequate debridement margin is subjectively assessed. Since the “paprika” method does not work well for dense cortical bones, and introduces the risk of further hematogenous infection, alternatives have been sought.

At many sites, surgical minimization is accomplished with an iterative approach, in which patients reside in hospital beds while specimens are examined histologically. Our goal in this proposal is to provide surgeons and podiatrists with immediate feedback as to tissue viability and bacterial load, thereby allowing procedures to be accomplished more conservatively and confidently, while decreasing the duration of hospital stays.

Generally speaking, the most common surgical guidance application is the use of a priori data sets (e.g., PET scans, x-ray films). Although traditionally these scans are viewed by surgeons prior to the procedure, it is possible to register the a priori data sets to position sensors for a road map view. One obvious drawback of a priori methods is that the road maps are not updated during surgery.

Intraoperative anatomic images have long been available for orthopedic and breast surgical procedures (e.g., using C-arm x-ray configurations, ultrasound). Bringing functional images (i.e., that provide information about physiology or biochemistry) into the operative suite is more challenging. It is possible to perform surgery within an MRI or PET scanner bore, or to rapidly move a patient into the bore in the course of surgery, but these are costly solutions which are not available to the large majority of patients, and which are inconsistent with many surgical procedures due to access limitations.

Hand-held radiation-counting devices (“probes”) have been used in surgical oncology, for intraoperative procedures in which patients received with tumor-avid radiotracers preoperatively. Hand-held gamma cameras have been promoted for clinical settings with high target-to-background contrast, such as localizations of sentinel nodes and removal of osteoid osteoma nidi.

Transferring technology from oncology to intraoperative wound care requires consideration of relevant clinical requirements. Except for high-contrast scenarios such as osteoid osteomas, radiotracer bone scans (e.g., with Tc-99 MDP) require long acquisition times to produce high confident images of surgical margins. Non-imaging probes are useful in detection of “hot spots” encountered in sentinel node procedures, but are less useful in defining the limits of normal tissue. Clinicians outside the nuclear medicine department are sometimes averse to the radiation exposure from such procedures, impeding market penetration.

Infrared imaging devices that can detect oxygenated blood flow (e.g., OxyVu) have been developed to assess long-term healing of diabetic foot ulcers. To our knowledge, these devices have not yet been evaluated intraoperatively. For validation and clinical purposes, it would be useful if we could identify the difference between diseased and normal tissue, even after the tissue has been resected. It would be difficult to perform such a specimen study with OxyVu instrumentation, since it relies on blood flow as the source of signal.

Many exogenous contrast materials are available which are optically-active, but only a few of these can be administered safely to a patient prior to surgery. Tetracycline, administered to patients for months prior to surgery, has been used in some studies as a marker for cell viability. Intraoperative ultraviolet lights have been used to detect tetracycline fluorescence in order to confirm that margins are clear of necrotic tissue. One drawback of this technique is the long loading time of the contrast material, which may lead to inaccurate identification if the patient's condition changes within weeks prior to surgery. Another drawback is that some patients may be allergic to tetracycline. ¶

Fluorescence is exhibited naturally by many organisms, primarily from NADH. NADH is the reduced form of nicotinamide adenine dinucleotide (“NAD”). NADH is component of the Krebs cycle, with broad application to biological assays. In most aerobic cells, NADH is chemically oxidized to NAD, which is not fluorescent. NADH is therefore a reasonable candidate as an endogenous signature of nonviable bone tissue and for active infectious organisms. Nelson et al [N Nelson, S Prakash, D Sander, A Sarje, M Dandin, H Ji, P Abshire. A Handheld Fluorometer for UV Excitable Fluorescence Assays [IEEE Proceedings of the 2007 Biomedical Circuits and Systems Conference (BIOCAS), pages 111-114], the subject matter of which is herein incorporated by reference, constructed fluorometers using active pixel sensors (APS) by shielding low-noise photodetectors from UV LEDs (375 nm) to look at the signal from NADH. The photodetectors were shielded from ambient light and from the excitation source by employing spectral coatings of chromophore (2-hydroxy 5-methylphenyl benzotriazole) mixed into a polymer matrix (Humiseal 1831), which was then cast onto the APS detectors. The chromophore filter had a long-pass characteristic with 400 nm cut-on frequency and 6 o-dB rejection in the UV region, suitable for imaging UV-excitable fluorophores with emission wavelengths above 400 nm. NADH fluorescence is centered at 450 nm.

### BRIEF SUMMARY OF THE INVENTION

From a surgeon or podiatrist's point of view, it is critical to know whether a tissue (e.g., a portion of bone) is viable or not. If it is viable, the surgeon should let it remain in the body, while necrotic (i.e., dead) regions should be removed. Live bone cells, once removed from the blood supply in the surgical region of interest, will begin the process of dying soon after removal. Portions of bone that were dead before they were removed will obviously still be dead after removal. By taking a sample of the bone from the region of interest in the body, and assessing the duration since demise, it is possible to determine whether the remainder of the bone cells in the surgical region of interest are likely to be alive or not. It is an object of the invention to provide a method and apparatus for assessing the time since demise of one or more tissue components, comprising a source of radiation to generate excitatory radiation toward a tissue, the tissue generating responsive radiation in response to the excitatory radiation, a sensor to receive the responsive radiation from the tissue and create a signal, a processor connected to the sensor to receive the signal from the sensor and wherein the tissue generates responsive radiation as a result of excitation of at least one intrinsic tissue metabolic product.

### BRIEF DESCRIPTION OF THE DRAWINGS

The present invention will now be described in connection with one or more drawings, in which:

FIG. 1 is a graph of experimental observations of the fluorescence obtained from a dying bone;

FIG. 2 is a diagram of a fluorescence camera setup;

### DETAILED DESCRIPTION OF THE INVENTION

The present invention will now be described in connection with one or more contemplated embodiments. The embodiments discussed are not intended to be limiting of the scope of the present invention. To the contrary, the embodiments described herein are intended to be exemplary of the broad scope of the present invention. In addition, those skilled in the art will appreciate certain variations and equivalents of the embodiments described herein. The present invention is intended to encompass those equivalents and variations as well.

One aspect of the present invention is to provide an apparatus and a method that consists of a detector or array of detectors sensitive to the fluorescence from bone exposed to ultraviolet light, where said fluorescence is a function of the bone viability. We conducted a pilot study involving bone chips from a freshly-slaughtered rat, which had been discarded after a prior experimental study. We began acquisition of data within 15 minutes of the animal's demise, employing a portable fluorometer prototype like the one described above. The rinsed bone chip (tissue component) was placed adjacent to the ultraviolet-producing light emitting diode and data sampled every twenty seconds. Experiments were conducted in a non-electrically controlled environment.

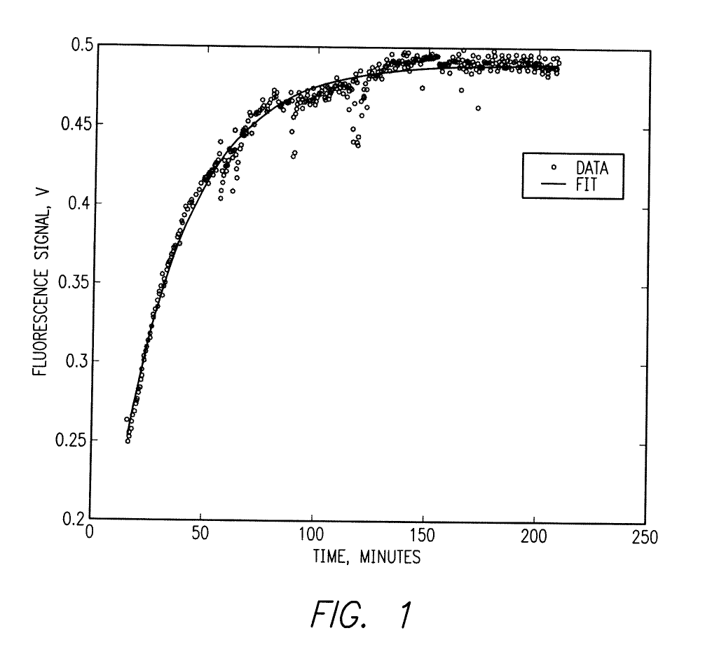

Experimental observations of the fluorescence obtained from a dying bone are shown in FIG. 1. The animal was sacrificed at time zero, and a femoral bone removed. The x-axis in the graph of FIG. 1 represents time in minutes after the animal was sacrificed, with the last measurement obtained 300 minutes after the removal. The y-axis represents the amount of fluorescence in arbitrary units as measured in voltage from the detector. Experimental data are shown in circles, fitted with a line. The graph (line) in FIG. 1 represents a signal. At three hours, the signal appears to have stabilized, i.e., corresponding to dead bone. Transients in the signal were temporally correlated with surges in the power supply to the non-ruggedized electronics.

Representative data of FIG. 1 can be summarized in the table below:

| | | | | | | | | | | |
|---|---|---|---|---|---|---|---|---|---|---|
| Time | 20 | 40 | 60 | 80 | 100 | 120 | 140 | 160 | 180 | 200 |
| (minutes) | | | | | | | | | | |
| Signal | 0.27 | 0.39 | 0.42 | 0.47 | 0.47 | 0.46 | 0.49 | 0.49 | 0.49 | 0.49 |
| (Volts) | | | | | | | | | | |

The data of FIG. 1 were found to be proportional to a function with an exponential term. The fitted function can be represented as A−B*exp(−t/T), where A and B are constants that are dependent on the optical geometric setup, t is the number of minutes elapsed since the animal was sacrificed, and T is a constant with approximate value 30 minutes. Note that the slope of the fitted function is proportional to exp(−t/T), which is itself a function of time. As a result, it is possible to collect data over a period of time (Tdelta) starting an arbitrary time Tarb (e.g., from time=Tarb to time Tarb+Tdelta), in order to determine the slope of the curve at Tarb. With that slope measurement it is possible to approximate the time Tarb since the demise of the tissue. This principle can allow an estimate of the time since demise of the bone to be conducted without having to collect data from the entire curve, and without the need for absolute measurement of the amplitude of the fluorescent signal.

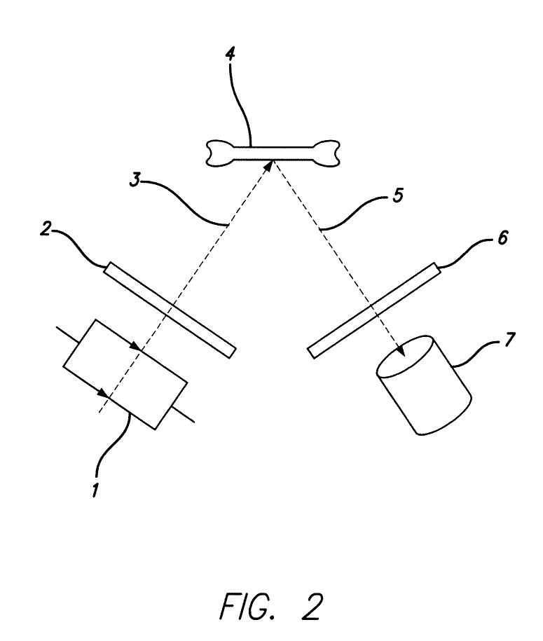

In other experiments we replaced the non-imaging fluorometer setup with a filtered digital camera (filtering out UV light) with the sample illuminated by a bright UV LED followed by a filter (filtering out visible light). The revised apparatus is diagrammed in FIG. 2, including a representative image. The distance from bone specimen to LED array was approximately 10 cm and the distance between bone specimen and camera was approximately 10 cm.

We conducted additional experimental studies involving bones from rats freshly sacrificed as in the previously described studies. Unlike the earlier experiments which involved single gross measurements of the bone specimen, in these refined experiments we employed a filtered digital camera (filtering out UV light) with the sample illuminated by a bright UV LED followed by a filter (filtering out visible light). The revised apparatus is diagrammed in FIG. 2, including a representative image. The distance from bone specimen to LED array was approximately 10 cm and the distance between bone specimen and camera was approximately 10 cm.

FIG. 2 is a diagram of an exemplary embodiment of the invention. In the illustrated embodiment, ultraviolet light is produced from a source of radiation such as one or more light-emitting diodes 1. Alternatively the source may be a laser or a broadband source of light such as an incandescent lamp, or a fluorescent lamp. Alternatively the source may emit other forms of radiation such as x-rays. The emission from source 1 may be filtered with a material 2 that attenuates visible light to a lesser extent than it attenuates spectra that can excite fluorescence from a marker reflecting the time since bone death. The resulting transmitted beam 3 is thus primarily in the ultra-violet spectrum. In an alternative embodiment, source 1 does not require filtering because it emits radiation that selectively excites fluorescence from a marker reflecting the time since tissue death. In one embodiment, the tissue is bone, although in an alternative embodiment the tissue may be other than bone. Fluorescent beam 5 is excited from tissue 4. In the illustrated embodiment, the fluorescent beam is filtered by a material 6 that attenuates ultraviolet light (or in general terms, light with the spectrum emitted by source 1) more than it attenuates the fluorescent beam 5. In an alternative embodiment, material 6 is not necessary, for example if the detector 7 is not sensitive to the light from source 1, or if the geometry of illumination of tissue 4 is such that the light from source 1 is not captured efficiently by detector 7. Detector 7 may be a camera, in which case an image of tissue 4 is collected and displayed to a user. Alternatively, detector 7 may be a non-imaging device that gives a measurement of fluorescence that can be used to assess the time since demise of the tissue. Comparison may be made between the fluorescent image or signal and the image or signal derived from illumination of the tissue by source 1 or other sources. Images or other signals from detector 7 may be analyzed using computer methods in which various weightings are assigned to portions of the color spectrum. Images or other signals from detector 7 may also be analyzed using computer methods in which signals at different time points are compared to see where the specimen fits along a curve similar to that shown in FIG. 1.

The invention whose embodiment is shown in FIG. 2 can be constructed in various manners, with housings and/or filters to reduce extraneous illumination, additional light-emitting diodes or other sources of excitatory radiation, software to highlight and analyze image features at certain fluorescent wavelengths, readiness for an operating room environment, and other changes that would be obvious to those familiar with the art. The reduction of extraneous illumination has the beneficial effect of improving the contrast-to-noise ratio, since as an example the sensor may be sensitive to both the illumination from the source and the fluorescence signal. Thus the source acts as a background that can overwhelm or otherwise interfere with the desired fluorescent signal. By reducing the amount of light from the source (i.e., with a filter) that is in the spectral range of the sensor, or adding a filter to the sensor so that it is insensitive to the source's spectrum, the background level is effectively reduced.

The invention is intended for use intraoperatively (or immediately after surgery) by a physician removing bone. The physician needs to know which portions of the bone (tissue) is viable and which is not viable. Assessing the time since demise of one or more tissue components entails removing a tissue component from a body; generating excitatory radiation from a source of radiation toward the tissue component, the tissue component generating responsive radiation in response to the excitatory radiation, sensing (over a period of time) the responsive radiation from the tissue component and creating a signal, then sending the signal to a processor (not shown) for analyzing the signal and estimating the viability of tissue components remaining in the body based on the processor's assessment of time since demise of the tissue component. The processor will have an appropriate display indicating the result, e.g., where on a curve like that of FIG. 1 the responsive radiation for the tissue component is found and thus indicating the viability of the tissue component. An operator will examine the bone with the method and apparatus of the present invention in order to ascertain viability (if there is too much fluorescence, the bone is not viable at the time of its removal from the body). The operator may be assisted by software. The information derived from the examination will be useful to the physician as he or she carries out the bone-removal (or other wound-healing) procedure.

As noted above, there are numerous variations and equivalents of the present invention that should be appreciated by those skilled in the art. The present invention is intended to encompass those equivalents and variations.

What is claimed is:

1. A device for assessing the time since demise of one or more tissue components, comprising:
a source of radiation to generate excitatory radiation toward a tissue component, the tissue component generating responsive radiation in response to the excitatory radiation;
a sensor to receive the responsive radiation from the tissue component and create a signal;
a processor connected to the sensor to receive the signal from the sensor; and
wherein processed signal provides information whereby a user can assess the time since demise of the tissue component based on responsive radiation generated by the tissue component as a result of excitation of at least one intrinsic tissue component metabolic product.

2. The device of claim 1, wherein the sensor polls at more than one time in order to determine the rate of change of the responsive radiation; and
wherein the processor includes a display adapted to indicate the rate of change of the responsive radiation which rate of change correlates with the time since demise of the tissue component.

3. The device of claim 1, where the assessment of time since demise of the one or more tissue components removed from a body is used to estimate the viability of tissues remaining in the body.

4. The device of claim 1, further comprising a filter along the path from the source of radiation for filtering the excitatory radiation.

5. The device of claim 1, further comprising a filter along the path from the tissue to the sensor for filtering responsive radiation.

6. The device of claim 1, where the sensor is an array that can be used to form an image derived from the responsive radiation emitted by the one or more tissue components that is related to the excitation of an intrinsic metabolic product.

7. The device of claim 6, where the sensor is an array that can be used to form an optical image of the tissue that is not related to the excitation of an intrinsic metabolic product;
and said optical image is correlated with the image derived from the responsive radiation that is related to the excitation of an intrinsic metabolic product.

8. A method for assessing the time since demise of one or more tissue components, comprising:
removing a tissue component from a body;
generating excitatory radiation from a source of radiation toward the tissue component, the tissue component generating responsive radiation in response to the excitatory radiation;
sensing the responsive radiation from the tissue component and creating a signal; and
sending the signal to a processor for analyzing the signal, and
estimating the viability of tissue components remaining in the body based on the assessment of time since demise of the tissue component.

9. The method of claim 8, further comprising periodically polling the sensor to determine the rate of change of the responsive radiation;
assessing the rate of change of the responsive radiation to determine the time since demise of the one or more tissue components.

10. The method of claim 8, further comprising filtering the excitatory radiation along the path from the source of radiation to the tissue.

11. The method of claim 8, further comprising filtering the responsive radiation along the path from the tissue to the sensor.

12. The method of claim 8, wherein the sensing further comprises sensing by an array that can be used to form an image derived from the responsive radiation emitted by the one or more tissue components that is related to the excitation of an intrinsic metabolic product.

13. The method of claim 12, wherein the sensing further comprises sensing by an array that can be used to form an optical image of the tissue that is not related to the excitation of an intrinsic metabolic product;
and correlating the optical image with the image derived from the responsive radiation that is related to the excitation of an intrinsic metabolic product.
